(19) United States
(12) Patent Application Publication
(10) Pub. No.: US 2013/0162032 A1
(43) Pub. Date: Jun. 27, 2013

(54) ENERGY SUPPLY UNIT FOR AN ELECTRIC VEHICLE AND ELECTRIC VEHICLE

(71) Applicant: Phillipp Matt, Frastanz (AT)

(72) Inventor: Phillipp Matt, Frastanz (AT)

(73) Assignee: BRUSA Elektronik AG, Sennwald (CH)

(21) Appl. No.: 13/821,206

(22) PCT Filed: Oct. 19, 2011
(86) PCT No.: PCT/IB11/54670

§ 371 Date: Mar. 14, 2013

Related U.S. Application Data
(60) Provisional application No. 61/414,806, filed on Nov. 17, 2010.

(30) Foreign Application Priority Data
Nov. 17, 2010 (EP) 10191588

(51) Int. Cl. B60L 9/12; B60L 11/06

(52) U.S. Cl. CPC B60L 9/12; B60L 11/06
USPC 307/10.1

(57) ABSTRACT

An energy supply unit (15) for an electric motor vehicle (1b) comprises a first interface (10) on the alternating voltage side to a vehicle-external power network, a second interface (16) on the direct voltage side for the connection to an onboard power system of the electric motor vehicle (2b), and an AC/DC converter (17) arranged in a current path between the first interface (10) and the second interface (16). Additionally, the energy supply unit (15) comprises a third interface (18) on the alternating N voltage side, for the connection to an alternating voltage generator (12) and a switching device (19) to connect the second interface (16) to the first interface (10) or the third interface (18) via the AC/DC converter (17). The AC/DC converter (17) may be connected to said vehicle-external power network or to said alternating voltage generator (12), which is driven by a combustion engine (11). In addition, an electric motor vehicle (1b) having such an energy supply unit (15) is set forth.

This application is a 35 U.S.C. 371 national-phase entry of PCT International application no. PCT/IB2011/054670 filed on Oct. 19, 2011 and also claims benefit of priority to prior European application no. EP10191588 filed on Nov. 17, 2010, and also claims priority as a non-provisional of U.S. provisional application Ser. No. 61/414,806 filed on Nov. 17, 2010, and both European application no. EP10191588 and U.S. provisional application Ser. No. 61/414,806, as well as parent PCT International application no. PCT/IB2011/054670, are all incorporated herein by reference in their entireties for all intents and purposes, as if identically set forth in full herein.

The invention relates to an energy supply unit for an electric motor vehicle comprising an AC first interface, which is provided for the connection to a vehicle-external power system, a DC second interface which is provided for the connection to an on-board power system of the electric motor vehicle, an AC/DC converter arranged in a current path arranged between the first and second interface, a third interface on the alternating voltage side, which is provided for the connection to an alternating voltage generator, and a switching device which makes possible the optional connecting of the second interface to the first or third interface via the AC/DC converter. Furthermore, the invention relates to an electric motor vehicle comprising a plug/a socket which is provided for connecting the vehicle to a vehicle-external power network, an on-board power system comprising an accumulator and a drive motor connected to said accumulator and a range extender comprising an energy converter for generating alternating current.

Electric motor vehicles as a rule have a plug/a socket via which an energy supply unit arranged in the vehicle can be connected to a vehicle-external power network, for example an alternating current power network with 230 v or 400 v rated voltage. On the DC voltage side the energy supply unit is connected to an on-board power system of the vehicle which comprises an accumulator and a drive motor connected with said accumulator. In this manner, the drive accumulator or the drive battery can be charged by way of the alternating current network. The energy supply unit then acts as charging device. Also known are energy supply units that enable the bidirectional energy transfer and thus principally the operation of an alternating current consumer via the drive battery. Such a device is disclosed for example in US 2008/0316774A1.

Furthermore, DE 102008063465A1 discloses an electric car having a battery, an electric motor and an inverter. The inverter can be used for driving the motor and as a charging device for charging the battery via a power grid. For this reason the voltage in the intermediate circuit of the inverter is set to at least 650V so that a sinusoidal current is obtained.

In addition, EP 0553824A1 discloses another system, which uses an inverter for driving an electric motor and as a charging device for charging the battery via a power grid. For this reason, the AC-side of the inverter may be switched to the motor or to a charging interface.

However, using the inverter for driving the electric motor of an electric vehicle as a charging device involves several drawbacks:

the voltage level of the inverter for driving the motor is much higher than the voltage level of an inverter for charging the battery in general. Accordingly, the inverter for driving the motor does not really fit to the requirements of a charging device.

the power to be transferred via said driving inverter (currents may reach 200-300 A) is much higher than the power to be transferred when charging the battery (currents are usually in the range of 30 A). Accordingly, a switch for switching the AC-side of the inverter to the power grid has to withstand very high currents and is thus bulky and expensive.

Furthermore, as a rule there is no potential separation, i.e. a transformer, between the battery and the driving inverter because of the bad efficiency of such an arrangement, which leads to some further drawbacks:

if the battery is charged by means of said driving inverter, the high voltage of the battery may be switched to the power grid in case of damage. This would lead to uncontrolled currents as the circuit breakers on the grid side are designed to control alternating current and would not cut off the battery from the grid.

the capacitances between both potentials of the battery and ground are relatively high and cause relatively high alternating currents if the battery is linked to the grid via said driving inverter. Accordingly, a circuit breaker on the grid side may cut off the connection unintentionally.

both potentials of the battery of an electric car are insulated against ground, which is supervised by means of an insulation monitor. If the battery is connected to the grid by means of the driving inverter used for the motor, the negative potential of the battery is pulled to ground what would cause an alert of the insulation monitor.

the voltage of the battery should be higher than the peak voltage of the power grid as the driving inverter for driving the motor usually is designed as a boost-converter. If the voltage of the batter is below the peak voltage of the power grid in this case, the power grid may be loaded in an uncontrolled manner.

Yet another major problem of electric motor vehicles available today is the low range due to the low energy density of the accumulators used. Electric motor vehicles therefore have to be charged after a distance covered of approximately 100 km to 150 km. The problem here is that the accumulators cannot be charged very rapidly and that frequent quick charging drastically reduces their lifespan. The high currents during quick charging also cause technical problems in that the charging devices and charging stations have to be dimensioned for such a current and accordingly are voluminous, heavy and expensive. Particularly in the case of on-board internal charging devices this is a less feasible option. The charging of the accumulators therefore takes significantly longer as a rule than a refueling operation with conventional vehicles having a combustion engine and in addition still has to be performed more frequently.

In order to overcome these disadvantages so-called “range extenders” were proposed even some time ago. “Range extender” is the name for additional units in an electric vehicle which increase the range of the vehicle. Frequently, combustion engines, that is gasoline or diesel engines are frequently used for this which drive a generator which in turn supplies accumulator and electric motor. Alternatively, fuel cells were also proposed for this purpose which for example can be operated with oxygen/hydrogen or for example also with ethanol.

These range extenders thus require additional expenditure in that these have to be incorporated in some manner in the on-board power system. In the case of fuel cells this is comparatively simple since these already provide a DC voltage which is also used in most on-board power systems of the known electric motor vehicles. An example of how such a range finder can be incorporated in an on-board power system is disclosed in DE102008037064A1. Alternating voltage generators which for example are driven by a combustion engine by contrast as a rule have to be incorporated in the on-board power system with an AC/DC converter provided for this purpose.

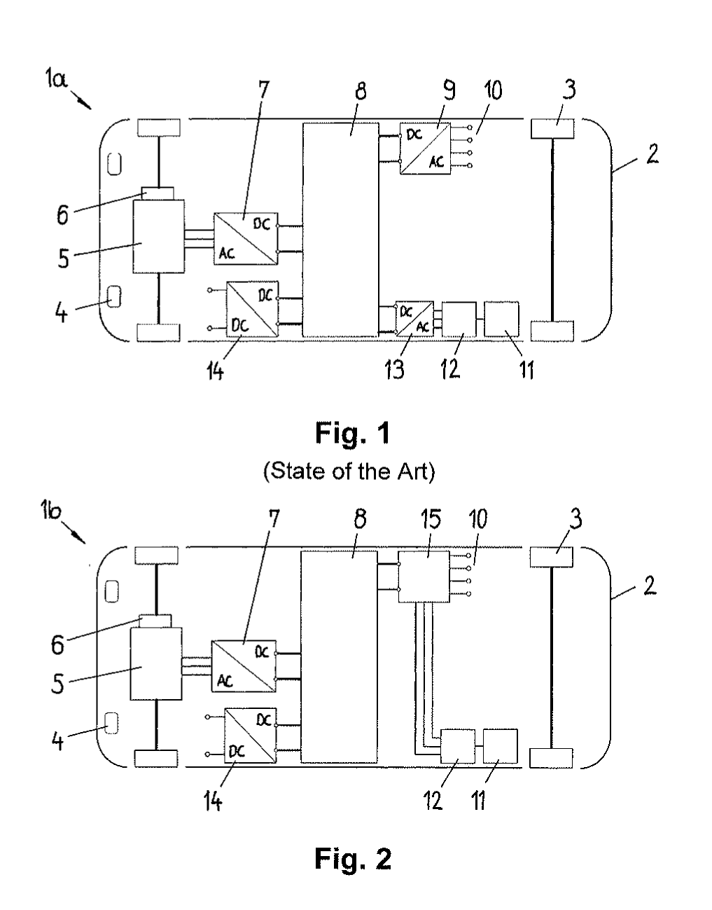

FIG. 1 shows such an arrangement according to the prior art in the form of an electric motor vehicle 1a. This comprises a chassis 2, wheels 3 and a lighting 4. In this example, the front wheels 3 are driven via a drive motor 5 with flanged-on transmission 6. The drive motor 5 is supplied with electric energy from the accumulator 8 via an inverter 7. The accumulator 8 can be charged in the already mentioned manner via a charging device 9 and a first interface 10 on the alternating voltage side, which is provided for the connection to a vehicle-external power network. In addition, the vehicle 1a comprises a combustion engine 11 which drives an alternating voltage generator 12 which in turn is connected to the on-board power system, in this case specifically to the accumulator 8, via an AC/DC converter 13 provided for this purpose. Finally the vehicle 1a additionally comprises a DC/DC transformer 14, which transforms the high voltage of the accumulator 8, which as a rule amounts to several hundred volts, to a low voltage of for example 12v, so that such low voltage consumers for example window lifters, lighting, entertainment system, navigation systems and the like can also be operated with the accumulator 8.

As can be readily seen, the AC/DC converter 13 requires additional technical expenditure, additional costs and in particular also additional weight for the vehicle 1a, which again reduces the range of the vehicle, which is desired to be extended. In this manner, a range extender is self-defeating to a certain degree.

The object of the invention now is to state an improved energy supply unit or an improved electric motor vehicle. In particular, the technical expenditure, the costs and also the vehicle weight when using a range extender are to be reduced. Furthermore, the drawbacks related to charging via a driving inverter mentioned above shall be avoided.

According to the invention, this object is solved through an energy supply unit of the type mentioned at the outset, wherein the AC/DC converter is designed to supply said on-board power system of the electric motor vehicle both via said vehicle-external power network or via said alternating voltage generator, which is driven by a combustion engine.

The object of the invention is also solved with an electric motor vehicle of the type mentioned at the outset, comprising an energy supply unit according to the invention, wherein the first interface is connected to the plug/the socket, the second interface to the on-board power system and the third interface to the energy converter.

According to the invention it is achieved by this that the technical expenditure, the costs and also the vehicle weight when using a range extender can be reduced since a separate AC/DC converter provided for the range extender (see AC/DC converter 13 in FIG. 1) can be omitted in that an AC/DC converter present in the charging device anyhow is co-utilized and thus serves a dual benefit. In addition to the cost reduction, the weight reduction presents a decisive advance compared with the known prior art, since the range of the vehicle and the CO2 emissions of the combustion engine of the range extender can be reduced by this. In particular, the invention can also be further understood in recognizing that an electric motor vehicle, as a rule, comprises a charging device with an AC/DC converter anyhow, which may also be co-used for the range extender.

Furthermore, the voltage level of a charging device fits to the requirements of an inverter for the range extender very well.

Finally, the switch for connecting the AC-side of the inverter to the power grid needs to be dimensioned just for relatively low currents (e.g. in the range of 30 A).

Advantageous configurations and further developments of the invention are obtained from the description viewed together with the figures or are disclosed by the latter.

It is advantageous if the inventive energy supply unit comprises a transformer between said second interface and said first interface respectively said third interface. The provision of a transformer, i.e. the provision of potential separation, leads to several advantages:

the integration of a transformer into a charging inverter does not involve any drawback for the efficiency of the driving inverter for driving the motor.

providing a potential separation avoids uncontrolled DC currents which are not detected by common AC circuit breakers.

undesired AC currents caused by the capacitances between both potentials of the battery and ground are avoided.

the negative potential of the battery is not pulled to ground so that an alert of an insulation monitor is avoided.

the voltage of the battery does not have to be higher than the peak voltage of the power grid.

It is advantageous if the AC/DC converter is embodied as bidirectional converter. In this manner, alternating current consumers, particularly vehicle-external alternating current consumers can for example be operated via the accumulator of the vehicle. It is also possible to start the combustion engine of the range extender in that the alternating voltage generator of the range extender is operated as (starter) motor and supplied with energy via the accumulator.

It is also advantageous if the mentioned switching device or a further switching device makes possible the connecting of at least one winding of the alternating voltage generator to the first interface and a connection of the AC/DC converter on the alternating current side. In this manner it is possible to use the inductances of the alternating voltage generator in charging mode via the network, that is when the generator is not driven via the combustion engine for smoothing the charging current. Separate voluminous and heavy smoothing chokes can thus be entirely or partially omitted.

It is also advantageous if the mentioned switching device or a further switching device makes possible the connecting of the first with the third interface. In this manner alternating current consumers, particularly vehicle-external alternating current consumers for example can be operated via the range extender of the vehicle. It is also possible to start the combustion engine of the range extender in that the alternating voltage generator of the range extender is operated as (starter) motor and supplied with energy via a vehicle-external power network. This is a major advantage for example when the accumulator of the vehicle is already emptied to the extent that its energy is no longer sufficient to start the combustion engine. According to the invention, one does not however have to wait for a charging period for the charging of the accumulator necessary for starting the combustion engine as is the case according to the prior art, but said combustion engine can be directly started from the alternating current network and thus without time delay. Driving with the electric motor vehicle can thus be immediately continued even with completely empty accumulator.

It is particularly advantageous in this connection if an AC/AC converter is arranged between the first and the third interface. In this manner, different voltage levels of the vehicle-external alternating current network and the alternating voltage generator can be adapted to each other, particularly when a vehicle intended for the European market is operated in the United States and vice versa, since different supply voltages are provided in each case.

It is also advantageous if the vehicle comprises a DC/DC converter which is arranged between the connection of the AC/DC converter on the direct voltage side and the second interface. With this version of the invention, different voltage levels of the vehicle-internal on-board system and the DC-output of the energy supply unit can be adapted to one another.

The above configurations and further developments of the invention can be combined in any desired manner.

The present invention is explained in more detail in the following drawings by means of the exemplary embodiments stated in the schematic figures of the drawing. There is shown:

FIG. 1a schematic representation of an electric motor vehicle according to the prior art;

FIG. 2 a schematic representation of an electric motor vehicle according to the invention;

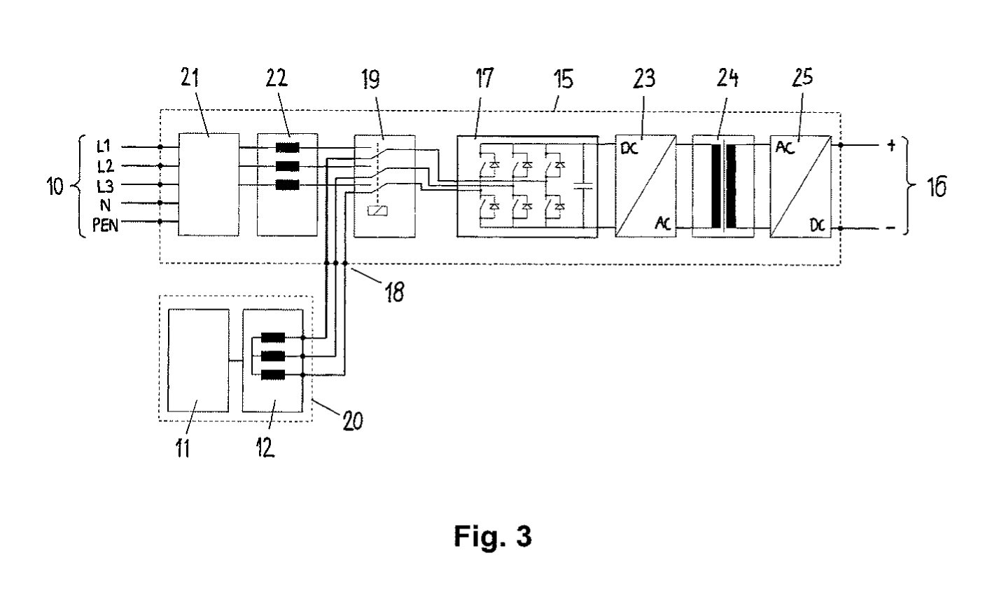

FIG. 3 an energy supply unit according to the invention and the range extender in detail;

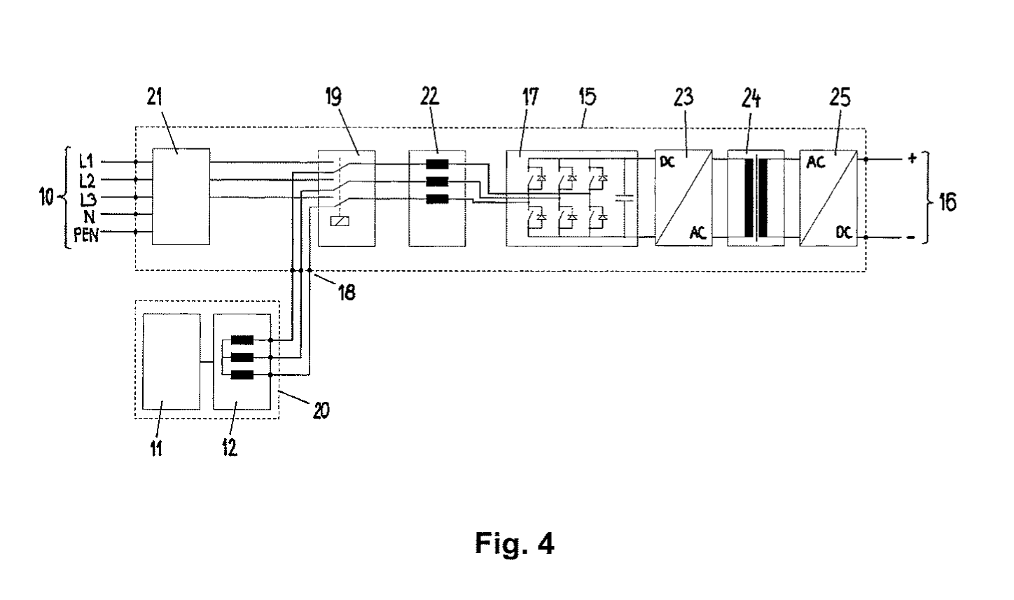

FIG. 4 an energy supply unit, wherein the switching element is arranged between the second interface and the triple PFC choke;

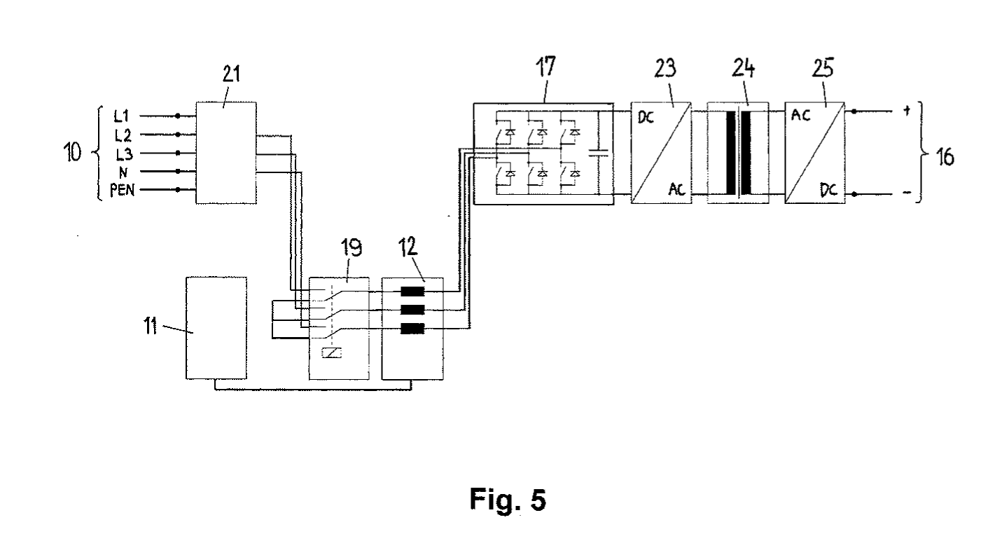

FIG. 5 an energy supply unit, wherein the windings of the alternating current generator are employed as smoothing chokes, and

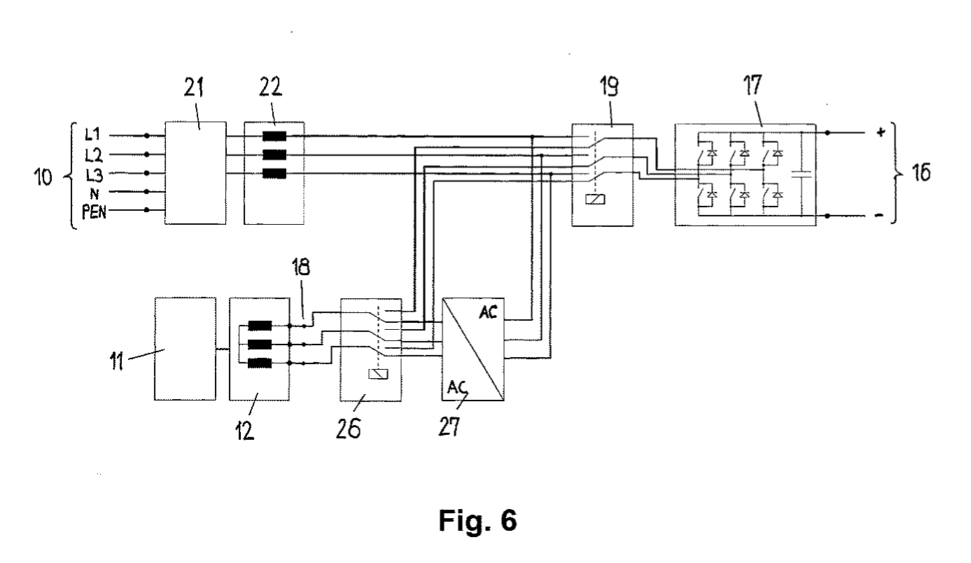

FIG. 6 a version of the energy supply unit wherein the first interface can be connected to the third interface.

In the Figures of the drawing, same and similar parts with same reference characters and functionally same elements and features—unless stated otherwise—are provided with same reference characters and if applicable different indices.

FIG. 2 shows an electric motor vehicle 1b according to the invention which is similar constructed as the electric motor vehicle 1a shown in FIG. 1. In contrast with this, however the charging device 9 and the AC/DC converter 13 are omitted. Instead, an energy supply unit 15 according to the invention is provided. Through this measure, the technical expenditure, the costs and also the weight of the vehicle 1b can be reduced.

FIG. 3 now shows the energy supply unit 15 in detail. It comprises a first interface 10 on the alternating voltage side (in this case exemplarily consisting of three alternating current phases L1 . . . L3, a neutral conductor N and an earthed conductor PEN), which is provided for the connection to a vehicle-external power network,
a second interface 16 on the direct voltage side, which is provided for the connection to an on-board power system of the electric motor vehicle 1b,
an AC/DC converter 17 arranged in a current path between the first and second interface 10 and 16,
additionally a third interface 18 on the alternating voltage side, which is provided for the connection to the alternating voltage generator 12, and
a switching device 19 which makes possible the optional connecting of the second interface 16 to the first interface 10 or the third interface 18 via the AC/DC converter 17. Thus, the on-board power system, which for the sake of simplicity is only formed by the accumulator 8 here, can be optionally supplied via a vehicle-external power network or via the range extender 20 comprising the combustion engine 11 and the alternating voltage generator 12.

Advantageously, the AC/DC converter 17 is embodied as bidirectional converter, so that on the one hand vehicle-external alternating current consumers can be operated via the accumulator 8 of the vehicle 1b or on the other hand the combustion engine 11 of the range extender 20 can also be started in that the alternating voltage generator 12 of the range extender 20 is operated as (starter) motor and supplied with energy via the accumulator 8.

In addition, the energy supply unit comprises an EMC filter 21 (“electromagnetic compatibility”) and a triple PFC choke 22 (“equals power factor correction”) for reducing the circuit feedbacks.

Finally the energy supply unit 15 comprises a DC/DC converter which is arranged between the connection of the AC/DC converter 17 on the direct voltage side and the second interface 16. It comprises a DC/AC converter 23, a transformer 24 and an AC/DC converter 25 and serves for the further voltage adaptation or for the galvanic isolation from the second interface 16 and thus from the on-board power system.

In a version of the invention which is shown in FIG. 4 the switching element 19 is arranged between the second interface 10 and the triple PFC choke 22. This arrangement is more preferably particularly advantageous if generators 12 with a very high number of poles are operated. These have a tendency to be smaller in size and also tend to have a lower leakage inductance. Thus, despite the mentioned low “generator leakage inductance” a sinusoidal current can be impressed on the AC/DC converter 17 since the inductance of the generator 12 and that of the triple PFC choke 22 are added.

FIG. 5 now shows a further version of the invention. There the switching device 19 is used for connecting the windings of the alternating voltage generator 12 to the first interface 10 and a connection of the AC/DC converter 17 on the alternating voltage side. In this manner, the inductances of the alternating voltage generator 12 in charging mode via the network, that is when the alternating voltage generator 12 is not driven via the combustion engine 11, can be used for smoothing the charging current. In this example the triple PFC choke 22 which is still present in FIG. 3 and FIG. 4 is therefore omitted entirely. However, it would also be conceivable that small additional chokes are still provided if the inductances of the alternating voltage generator 12 are not large enough. Alternatively it is also conceivable that it is not the switching device 19 that is employed for the mentioned purpose, but a switching device specifically provided for this. Since the inductances of the alternating current generator 12 are dually utilized, a clear separation between the energy supply unit 15 and the range extender 20 is not possible here.

FIG. 6 now shows a further version of the invention. There, a further switching device 26 is provided for connecting the first interface 10 to the third interface 18. In addition, an AC/AC converter 27 is provided, which is arranged between the first interface 10 and the third interface 18. In this way it is possible to operate vehicle-external alternating current consumers via the range extender 20 of the vehicle. It is also possible to start the combustion engine 11 of the range extender 20 in that the alternating voltage generator 12 of the range extender 20 is operated as (starter) motor and is supplied with energy via a vehicle-external power network. The combustion engine 11 can thus be directly started from the vehicle-external alternating current network. To this end, the switching device 26 is controlled into the state shown and the switching device 19 into a state in which the second interface 16 is decoupled from the first interface 10 and the third interface 18. The switching system consisting of the switching device 19 and the switching device 26 in this example thus has three functional switching positions.

If the voltage levels of the vehicle-external alternating current network and of the alternating current generator 12 correspond to each other, the AC/AC converter 27 can also be omitted. Obviously, the versions shown in the FIGS. 3 to 6 can also be combined in any desired manner.

Finally it is noted that although the switching devices 19 and 26 are always represented as contactors or as relay respectively, these can also be embodied differently. For example the switching devices 19 and 26 can also be formed through semi-conductor switches.

It is additionally noted that the versions shown only constitute an extract of the many possibilities for an energy supply unit 15 according to the invention or an electric motor vehicle 1b according to the invention and must not be utilized to limit the application range of the invention. It should be easy to the person skilled in the art to adapt the invention to his requirements based on the considerations presented here without leaving the scope of protection of the invention. In addition it is pointed out that parts of the devices shown in the Figures can also form the basis for independent inventions.

### LIST OF REFERENCE CHARACTERS

1a, 1b Electric motor vehicle
2 Chassis
3 Wheel
4 Lighting
5 Drive motor
6 Transmission
7 Drive inverter
8 Accumulator
9 Charging device
10 First interface on the alternating voltage side
11 Combustion engine
12 Alternating voltage generator
13 AC/DC converter
14 DC/DC converter
15 Energy supply unit
16 Second interface on the direct voltage side
17 AC/DC converter
18 Third interface on the alternating voltage side
19 Switching device
20 Range extender
21 EMC filter
22 Triple PFC choke
23 DC/AC converter
24 Transformer
25 AC/DC converter
26 Further switching device
27 AC/AC converter
L1 . . . L3 Phases of the alternating current network
N Neutral conductor
PEN Earthed conductor

What is claimed is:

1-9. (canceled)

10. An energy supply unit for an electric motor vehicle comprising:
an alternating-voltage side in said supply unit;
a direct-voltage side in said supply unit;
a first interface in said alternating-voltage side, said first interface adapted for connection to an external power network;
a second interface in said direct-voltage side;
an on-board power system of the electric vehicle, said on-board power system connected to said second interface;
an AC/DC converter operationally connected between said first interface and said second interface;
a third interface in said alternating voltage side;
an alternating voltage generator connected to said third interface;
a switch arrangement configured to control electrical connection through said AC/DC converter and between said second interface and said first and third interfaces;
said switch arrangement having a first position, said first position connecting said AC/DC converter to supply said on-board power system of the electric vehicle by said external power network; and,
said switch arrangement having a second position, said second position connecting said AC/DC converter to supply said on-board power system of the electric vehicle by said alternating voltage generator.

11. An energy supply unit for an electric motor vehicle as claimed in claim 10, further comprising:
a transformer, said transformer disposed in an electrical path between said second interface and said first interface, and said transformer disposed in an electrical path between said second interface and said third interface.

12. The energy supply unit for an electric motor vehicle as claimed in claim 10, wherein:
said AC/DC converter is a bidirectional converter.

13. An energy supply unit for an electric motor vehicle as claimed in claim 10, further comprising:
said switch arrangement has a third position, said third position electrically connecting said first interface to said AC/DC converter through at least one winding of said alternating voltage generator.

14. An energy supply unit for an electric motor vehicle as claimed in claim 10, further comprising:
said switch arrangement has a third position electrically connecting said first interface to said third interface.

15. An energy supply unit for an electric motor vehicle as claimed in claim 14, further comprising:
an AC/AC converter electrically connected between said first interface and said third interface.

16. An energy supply unit for an electric motor vehicle as claimed in claim 10, further comprising:
a DC/DC converter electrically connected between said AC/DC converter and said second interface.

17. An electric motor vehicle comprising:
an electrical connector configured to connect external power to the vehicle;
an on-board vehicle power system;
an accumulator in said on-board vehicle power system;
a drive motor in said on-board vehicle power system, said drive motor being electrically connected to said accumulator;
a range-extender, said range-extender including an energy converter for generating alternating current;
an energy supply unit in said electric vehicle, said energy supply unit including an alternating-voltage side in said supply unit;
a direct-voltage side in said supply unit;
a first interface in said alternating-voltage side, said first interface adapted for connection to an external power network via said electrical connector;
a second interface in said direct-voltage side, said on-board vehicle power system connected to said second interface;
an AC/DC converter operationally connected between said first interface and said second interface;
a third interface in said alternating voltage side;
said energy converter for generating alternating current including an alternating voltage generator connected to said third interface;
a switch arrangement configured to control electrical connection through said AC/DC converter and between said second interface and said first and third interfaces;
said switch arrangement having a first position, said first position connecting said AC/DC converter to supply said on-board vehicle power system by said external power network; and,
said switch arrangement having a second position, said second position connecting said AC/DC converter to supply said on-board vehicle power system by said alternating voltage generator.

18. An electric motor vehicle as claimed in claim 17, further comprising:
a transformer, said transformer disposed in an electrical path between said second interface and said first interface, and said transformer disposed in an electrical path between said second interface and said third interface.

19. The electric motor vehicle as claimed in claim 17, wherein:
said AC/DC converter is a bidirectional converter.

20. An electric motor vehicle as claimed in claim 17, further comprising:
said switch has a third position, said third position electrically connecting said first interface to said AC/DC converter through at least one winding of said alternating voltage generator.

21. An electric motor vehicle as claimed in claim 17, further comprising:
said switch arrangement has a third position electrically connecting said first interface to said third interface.

22. An electric motor vehicle as claimed in claim 21, further comprising:
an AC/AC converter electrically connected between said first interface and said third interface.

23. An electric motor vehicle as claimed in claim 17, further comprising:
a DC/DC converter electrically connected between said AC/DC converter and said second interface.

24. An electric motor vehicle as claimed in claim 17, further comprising:
an internal combustion engine configured to drive said alternating voltage generator.

25. An electric motor vehicle comprising:
an electrical connector configured to connect external power to the vehicle;
an on-board vehicle power system;
an accumulator in said on-board vehicle power system;
a drive motor in said on-board vehicle power system, said drive motor being electrically connected to said accumulator;
a range-extender, said range-extender including an energy converter for generating alternating current;
an energy supply unit in said electric vehicle, said energy supply unit including an alternating-voltage side in said supply unit;
a direct-voltage side in said supply unit;
a first interface in said alternating-voltage side, said first interface adapted for connection to an external power network via said electrical connector;
a second interface in said direct-voltage side, said on-board vehicle power system connected to said second interface;
an AC/DC converter operationally connected between said first interface and said second interface;
a third interface in said alternating voltage side;
said energy converter for generating alternating current including an alternating voltage generator connected to said third interface;
a first switch configured to control electrical connection through said AC/DC converter and between said second interface and said first and third interfaces;
said first switch having a first position, said first position connecting said AC/DC converter to supply said on-board vehicle power system by said external power network;
said first switch having a second position, said second position connecting said AC/DC converter to supply said on-board vehicle power system by said alternating voltage generator;
a second switch, said second switch connected between said third interface and an AC/AC converter, said AC/AC converter electrically connected between said first interface and said third interface;
said second switch having a first position electrically connecting said third interface with said first switch; and,
said second switch having a second position electrically connecting said third interface with said first interface through said AC/AC converter.

26. An electric motor vehicle as claimed in claim 25, further comprising:
an internal combustion engine configured to drive said alternating voltage generator; and,
in said second switch second position, said first interface supplies current to operate said alternating voltage generator as an electric starting motor for said internal combustion engine.

27. The electric motor vehicle as claimed in claim 25, wherein:
said AC/DC converter is a bidirectional converter.

28. An electric motor vehicle as claimed in claim 27, further comprising:
a DC/DC converter electrically connected between said AC/DC converter and said second interface.

29. An electric motor vehicle as claimed in claim 28, further comprising:
a transformer, said transformer disposed in an electrical path between said second interface and said first interface, and said transformer also disposed in an electrical path between said second interface and said third interface.
